(19) United States
(12) Patent Application Publication
(10) Pub. No.: US 2009/0065542 A1
(43) Pub. Date: Mar. 12, 2009

(54) Spinning cross bar

(75) Inventor: Jeffrey J. Tuttle, Sterling Heights, MI (US)

Correspondence Address: Jeffrey Tuttle, 42177 Blairmoor, Sterling Heights, MI, 48313, US

(73) Assignee: Jeffrey John-Carl Tuttle, Sterling Heights, MI (US)

(21) Appl. No.: 11/900,284

(22) Filed: Sep. 12, 2007

(51) Int. Cl. B60R 9/052

(52) U.S. Cl. 224/323; 224/316

(57) ABSTRACT

The method of design of a wind driven spinning cross bar is disclosed. This spinning cross bar creates a unique styling accent to the automobile.

### BACKGROUND OF THE INVENTION

The invention relates to an automobile cross bar, more particularly a mechanism to allow the cross bar to spin or rotate, creating an aesthetically pleasing automobile styling accent. The design of such a cross bar and mechanism is disclosed herein.

### SUMMARY OF THE INVENTION

To create unique or custom styling for automobiles, it is desirable to create components that can freely move or spin. Cross bars, cross rails, or side rails, which will generally be referred to as cross bars herein, are support structures generally mounted on top of vehicle roofs, on top of trunks, inside truck beds, or on top of truck beds, generally for the purpose of providing a raised span for securing cargo. As these are visible exterior items, they are also part of the vehicle's styling. By creating a mechanism for these cross bars to freely spin, and further by creating a cross bar shape that will allow wind to force this spinning, the styling of the cross bar and thus the entire vehicle is enhanced. A preferred embodiment of such a spinning cross bar design is disclosed herein. Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DESCRIPTION OF THE DRAWINGS

FIG. 1 is a perspective view of a typical automobile roof with the present invention, spinning cross bars, installed;

FIG. 2 is a cross-sectional view of the bar in the spinning cross bar assembly;

FIG. 3 is a cross-sectional view of the low friction mounting of the spinning cross bar assembly and the mounting of said assembly to a raised rail;

FIG. 4 is a side view of a spinning cross bar assembly mounted to a non-raised or flat mounted rail;

FIG. 5 is a side view of a spinning cross bar assembly mounted directly to a vehicle surface secured by a magnetic attachment;

FIG. 6 is a side view of a spinning cross bar assembly mounted directly to a vehicle surface secured by a screw attachment;

FIG. 7 is a side view of a spinning cross bar assembly mounted directly to a vehicle surface with a low profile attachment;

### DETAILED DESCRIPTION OF THE INVENTION

The following description of the preferred embodiments is merely exemplary in nature and is in no way intended to limit the invention, its application, or uses.

### I. Spinning Mechanism

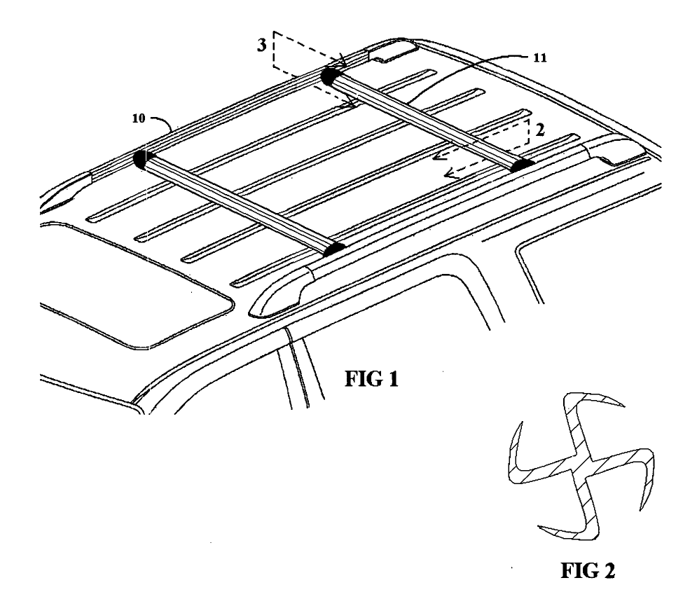

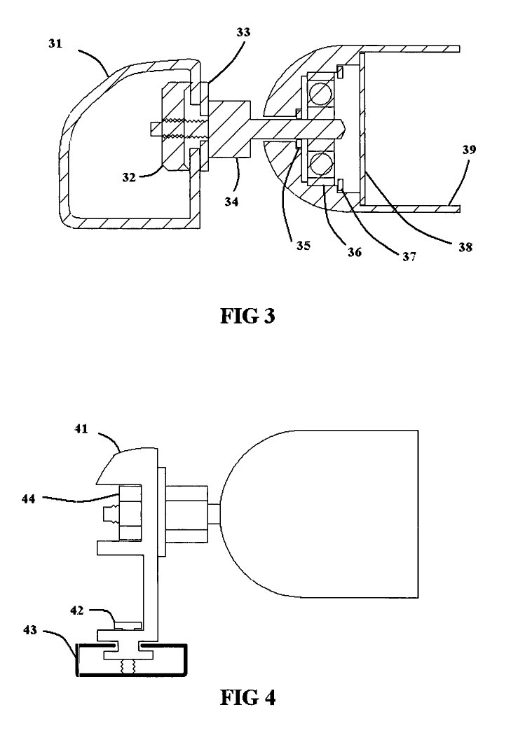

Cross bars, cross rails, or side rails, which will generally be referred to as cross bars herein, are support structures generally mounted on top of vehicle roofs, on top of trunks, inside truck beds, or on top of truck beds, generally for the purpose of providing a raised span for securing cargo. FIG. 1 shows a typical automobile roof with raised mounting rails, 10, which are aligned parallel to the longitudinal axis of the vehicle, and which contain a channel structure designed to facilitate the mounting of cross bars and other vehicle accessories. The first preferred embodiment of the spinning cross bar, 11, is shown mounted perpendicular to the raised mounting rails, 10. To allow the cross bar to rotate freely along its longitudinal axis, the bar must joint to a support structure with a low friction element. FIG. 3, the cross sectional view called out in FIG. 1, shows a preferred embodiment of a low friction mechanism which would allow such spinning. The assembly is secured to the mounting rail, 31, by the turning of the main axle, 34, which pulls the tapped plate, 32, and a washer, 33, together, cinching the mounting rail tightly between them. The spinning cross bar end support, 39, has an open shroud which allows the bar portion of the spinning cross bar to be press fit in place, allowing the end support and bar to rotate together. The rotation of the end support and bar around the fixed main axle, 34, is accomplished by the use of a roller bearing interface, 36. The bearing is held into place by a press fit or glued washer, 37. Moisture and contaminants are kept out of the assembly with a rubber washer, 35, sealing around the main axle, and a cap, 37, sealing off the other end of the assembly. While this assembly is the preferred embodiment, after review of this specification, it will become evident to those skilled in such mechanisms that many alternate structures can also serve as a low friction joint. For example, the roller bearing interface could be replaced with a low friction element without moving components such as a low friction plastic sleeve. Another evident variation would be to mount the low friction interface between the axle and the mounting rail instead of within the spinning cross bar end support.

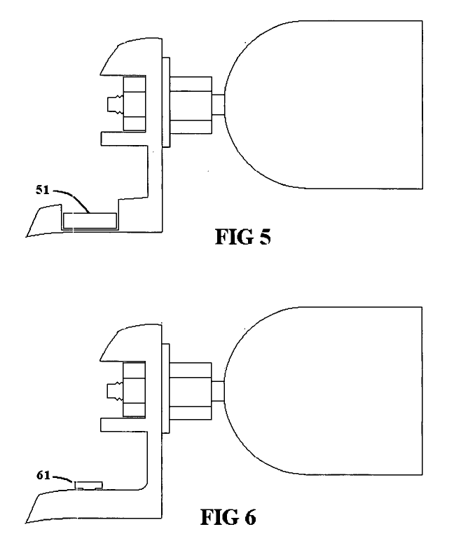

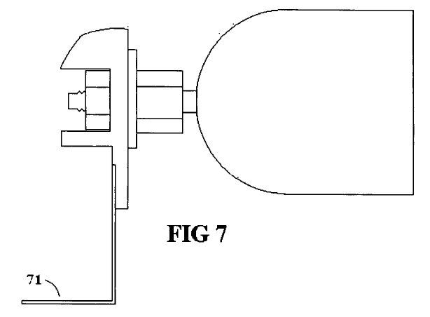

Within the industry, cross bars are mounted to mounting rails and vehicles in a variety of methods. The preferred embodiment of the spinning cross bar design per FIG. 3 is easily adaptable to a number of different mounting schemes. FIG. 4 shows another embodiment of the spinning cross bar design where the assembly is attached to a mounting support, 41, and held in place with a nut, 44. This mounting support provides an interface to a low profile mounting rail, 43, held in place by a bolt, 42. FIG. 5 shows an embodiment that also uses a mounting support, where said mounting support is secured to the vehicle roof with a magnet, 51. FIG. 6 shows an embodiment that also uses a mounting support, where said mounting support is attached to the vehicle roof with a screw, 61. FIG. 7 shows an embodiment that also uses a mounting support, where said mounting support has a thin metal lower portion, 71, that could be mounted underneath other mounting structures on the vehicle.

### II. Bar Shape to Facilitate Spinning From Wind Force

To achieve the desired spinning motion of the bar component of the spinning cross bar, the shape of the bar portion of the cross bar is designed to create more wind force or wind drag on one side of the bars longitudinal axis than the other, thus making a torque effect on the bar around its longitudinal access. In general, this is achieved by making a non symmetrical design where the projections off the longitudinal axis have a substantially concave shape, and wherein the direction of these curved projections are substantially equal in direction when each projection is rotated to the same radial position along the longitudinal axis. FIG. 2 shows one preferred embodiment of the spinning cross bar shape. To those with an understanding of aerodynamic principles many variations of this shape can be generated that will create the same aforementioned torque effect. In addition, it should be noted that the shape of the bar can also be adjusted based on the mounting position on the vehicle. Thus, if the bar was mounted parallel to the longitudinal axis of the vehicle, a spiral shape would create a torque around the longitudinal axis of the bar.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, specification, and following claims.

1. A cross bar, wherein said cross bar has a bar component of the assembly,
wherein said bar component has a shape designed to create a torque effect around the longitudinal axis of the bar when exposed to wind, and wherein said cross bar has a low friction mounting interface to allow the cross bar to spin when exposed to said wind.

2. The cross bar of claim 1 wherein said low friction mounting interface consists of a roller bearing.

3. The cross bar of claim 1 wherein said low friction mounting interface consists of a low friction plastic sleeve.

4. The cross bar of claim 1 wherein the design of said bar component shape to create a torque effect around the longitudinal axis of the bar is a achieved by creating a non symmetrical design where the projections off the longitudinal axis have a substantially concave shape, and wherein the direction of these curved projections are substantially equal in direction when each projection is rotated to the same radial position along the longitudinal axis.
